(19) United States
(12) Patent Application Publication
(10) Pub. No.: US 2022/0036225 A1
(43) Pub. Date: Feb. 3, 2022

(54) LEARNING PARAMETERS OF SPECIAL PROBABILITY STRUCTURES IN BAYESIAN NETWORKS

(71) Applicant: International Business Machines Corporation, Armonk, NY (US)

(72) Inventor: Eliezer Segev Wasserkrug, Haifa (IL)

(21) Appl. No.: 16/983,905

(22) Filed: Aug. 3, 2020

(51) Int. Cl. G06N 7/00; G06F 17/18; G06K 9/62

(52) U.S. Cl. CPC G06N 7/005; G06K 9/6215; G06F 17/18

(57) ABSTRACT

A computer-implemented method, a computer program product, and a computer system for data processing. An embodiment includes providing a Bayesian network model including a special model structure. The embodiment further includes learning probabilities between at least one node of the Bayesian network model and a parent node of the Bayesian network model, wherein learning the probabilities is performed by assuming no special model structure is included in the Bayesian network model. The embodiment further includes optimizing parameters that describe learned probabilities of the Bayesian network model including the special model structure and updating the Bayesian network model including the special model structure using the optimized parameters.

### BACKGROUND

The present invention relates to techniques that may extend any learning algorithm used for general Bayesian Networks to special model structures, thereby enabling both the advantages of general Bayesian Network learning algorithms such as the use of all data points and incorporating examples with missing data, together with the advantages of special structures, which include incorporating expert estimations of probabilities (requiring smaller number of estimates due to special structure), explainability and ongoing updates by the experts.

Bayesian Networks (BNs) are a leading type of model for probabilistic reasoning, with many advantages over conventional deep learning methods, including, for example, requiring significantly less data, being able to represent causality, being able to directly capture/build upon expert knowledge, and providing very good explainability.

Indeed, such models are expected to become more and more prominent in the coming years, due to the trend of combining deep learning models with more classical AI reasoning models, as well as the realization of the importance of enabling formal causal reasoning. There are also many standard algorithms for learning BN parameters. Such algorithms possess many useful features such as being able to work on data with missing values, as well as incorporating expert estimates together with historical data.

A Bayesian Network model can be roughly decomposed into two parts: A directed graph, which can capture both causal relations and some independence relations between the random variables in the graph, and some representation of a probability space, that captures the quantitative conditional probabilities between a node and its parent.

While in general, the conditional probabilities between a node and its parent can be any valid conditional probability space, in practice, in many cases, a special structure is assumed. Such structure is extremely useful in real world cases, as it both captures additional semantics found in those cases or can be used to more easily elicit probability estimates from experts—as the special structure often requires the estimation of a much smaller number of parameters.

As a concrete example, consider the noisy-or probability structure used in many use cases. Such a structure can be used to denote the conditional probabilities of a node and its parents, given that all of them are binary nodes. To specify a general conditional probability between a binary node and n parents in requires the specification of O(2ⁿ) parameters. However, assuming the noisy-or structure, this requires specifying only n+1 parameters. This is as for each parent i, one must specify a single parameter λᵢ, which is the probability that the child is true given that only the parent i is true (an additional parameter, λ₀ must be specified, which is the probability that the child occurred given that none of its parents occurred). The probabilities for all other cases (e.g., the probability that the child is true given that more than one parent is true) can then be calculated based on the underlying assumptions of the semantics of the noisy-or. As is apparent, the use of noisy-or not only requires the specification of far fewer parameters than the general case, but the underlying semantics can be used to elicit probability estimates from experts.

However, once such special structures are assumed, it is not trivial to use standard algorithms for learning Bayesian Network parameters. Again, taking noisy-or as an example, it is easy to use examples in which at most one parent is true. However, it is unclear how to use examples in which more than one parent is true. In addition, it is not trivial to use examples in which some of the values are missing, as it is unclear if in such examples at most one parent was true or not. Therefore, this may, in many cases, inhibit the size of the data sets that can be used in practice to learn the parameters of these networks.

Many techniques completely ignore this problem, while others provide specialized learning algorithms for specific structures, which do not generalize well or may not address the case of missing data values, thereby limiting the applicability of such structures.

Accordingly, a need arises for techniques that may extend any learning algorithm used for general BNs to these special model structures, thereby both enabling the use of both data points and incorporating examples with missing data.

### SUMMARY

In one aspect, a computer-implemented method for data processing is provided. The computer-implemented method includes providing a Bayesian network model including a special model structure; learning probabilities between at least one node of the Bayesian network model and a parent node of the Bayesian network model, wherein learning the probabilities is performed by assuming no special model structure is included in the Bayesian network model; optimizing parameters that describe learned probabilities of the Bayesian network model including the special model structure; and updating the Bayesian network model including the special model structure using optimized parameters.

In another aspect, a computer system for data processing is provided. The computer system comprises a processor, memory accessible by the processor, and computer program instructions stored in the memory and executable by the processor. The program instructions are executable to perform providing a Bayesian network model including a special model structure. The program instructions are further executable to perform learning probabilities between at least one node of the Bayesian network model and a parent node of the Bayesian network model, wherein learning the probabilities is performed by assuming no special model structure is included in the Bayesian network model. The program instructions are further executable to perform optimizing parameters that describe learned probabilities of the Bayesian network model including the special model structure. The program instructions are further executable to perform updating the Bayesian network model including the special model structure using optimized parameters.

In yet another aspect, a computer program product for data processing is provided. The computer program product comprises a computer readable storage medium having program instructions embodied therewith, and the program instructions are executable by one or more processors. The program instructions are executable to perform: providing a Bayesian network model including a special model structure; learning probabilities between at least one node of the Bayesian network model and a parent node of the Bayesian network model, wherein learning the probabilities is performed by assuming no special model structure is included in the Bayesian network model; optimizing parameters that describe learned probabilities of the Bayesian network model including the special model structure; and updating the Bayesian network model including the special model structure using optimized parameters.

In embodiments, learning the probabilities comprises evaluating the Bayesian network model without the special model structure using data. Learning the probabilities further comprises generating a weight using a function for each set of values.

In embodiments, optimizing the parameters comprises determining a set of parameters that minimizes a distance function between probabilities derived from determined parameters of the special model structure and the learned probabilities. Optimizing the parameters further comprises generating a weight of the distance function by a number of values present for each case.

In embodiments, the special model structure is a non-generic Conditional Probability Distribution (CPD), including one of a noisy-or probability model structure, a generalized linear model, a deterministic conditional probability distribution, and a context specific conditional probability distribution.

### BRIEF DESCRIPTION OF THE SEVERAL VIEWS OF THE DRAWINGS

The details of the present invention, both as to its structure and operation, can best be understood by referring to the accompanying drawings, in which like reference numbers and designations refer to like elements.

FIG. 1 is an illustration of a special model structure such as a noisy-or model Bayesian network, in accordance with one embodiment of the present invention.

FIG. 2 is a flow diagram of a process of extending an algorithm used for general Bayesian networks to special model structures, in accordance with one embodiment of the present invention.

FIG. 3 is block diagram of a computer system in which processes involved in the embodiments described herein may be implemented, in accordance with one embodiment of the present invention.

### DETAILED DESCRIPTION

Embodiments of the present invention provide techniques that may extend any learning algorithm used for general BNs to the special structures, thereby enabling both the advantages of general BN learning algorithms such as the use of all data points and incorporating examples with missing data, together with the advantages of special structures, which include incorporating expert estimations of probabilities (requiring smaller number of estimates due to special structure), explainability and ongoing updates by the experts.

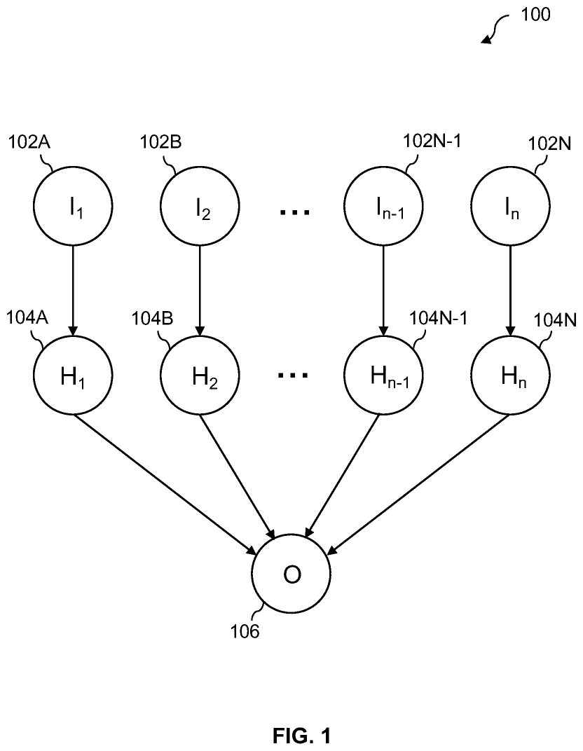

An example of special model structure, a noisy-or model Bayesian network 100, is shown in FIG. 1. The noisy-or Bayesian network model 100 concerns inputs that independently generate an output. In this example, there are n inputs I₁ 102A, I₂ 102B, . . . , Iₙ₋₁ 102N-1, and Iₙ 102N of an output O 106. The variables H₁ 104A, H₂ 104B, . . . , Hₙ₋₁ 104N-1, and Hₙ 104N are hidden variables. The model assumes that each input I₁ 102A, I₂ 102B, . . . , Iₙ₋₁ 102N-1, and Iₙ 102N being true will result in O 106 being true, regardless of the truth of the other inputs, unless the input is inhibited. Each input I₁ 102A, I₂ 102B, . . . , 102N-1, and Iₙ 102N has a probability of being inhibited when it is true. It is to be noted that the noisy-or model Bayesian network 100 is merely an example of a special model structure. The present technique are equally applicable to any special model structure. Another example of a special structure is a generalized linear model, which is a class of models that also satisfy independence of causal influence. For example, consider a conditional probability distribution (CPD) of Y given X₁, . . . , Xₖ. The effect of the Xᵢ's on Y may be summarized via a linear function

$$f ( {X}_{1} , … , {X}_{k} ) = {\sum }_{i - 1}^{k} {ω}_{i} {X}_{i} ,$$

where we again interpret xᵢ¹ as 1 and xᵢ⁰ as 0. In this example, this function may be the total burden on the immune system, and the ωᵢ coefficient describes how much burden is contributed by each disease cause. The next question is how the probability of Y=y¹ depends on f(X₁, . . . , Xₖ). In general, this probability undergoes a phase transition around some threshold value τ: when f(X₁, . . . , Xₖ)≥τ, then Y is very likely to be 1; when f(X₁, . . . , Xₖ)<τ, then Y is very likely to be 0. It is easier to eliminate τ by simply defining

$$f ( {X}_{1} , … , {X}_{k} ) = {ω}_{0} + {\sum }_{i - 1}^{k} {ω}_{i} {X}_{i} ,$$

so that ω₀ takes the role of −τ. To provide a realistic model for many examples, a hard threshold function may not be used to define the probability of Y, but rather a smoother transition function may be used. One common choice (although not the only one) is the sigmoid or logit function:

$$sigmoid ( z ) = \frac{{e}^{z}}{1 + {e}^{z}} .$$

Another example of a special structure is a deterministic conditional probability distribution (CPD); for example, when a variable X is a deterministic function CPD of its parents Pa_{X}, that is, there is a function f: Val(Pa_{X})→Val(X), such that

$$P ( x \vert p {a}_{X} ) = \{ \begin{matrix}1 & x = f ( p {a}_{X} ) \\ 0 & otherwise .\end{matrix}$$

Yet another example of a special structure is a context specific CPD in which deterministic dependencies arise in several contexts.

This method can also work in a network where some of the nodes are of one type (e.g., noisy-or) while others are of another type (e.g., deterministic).

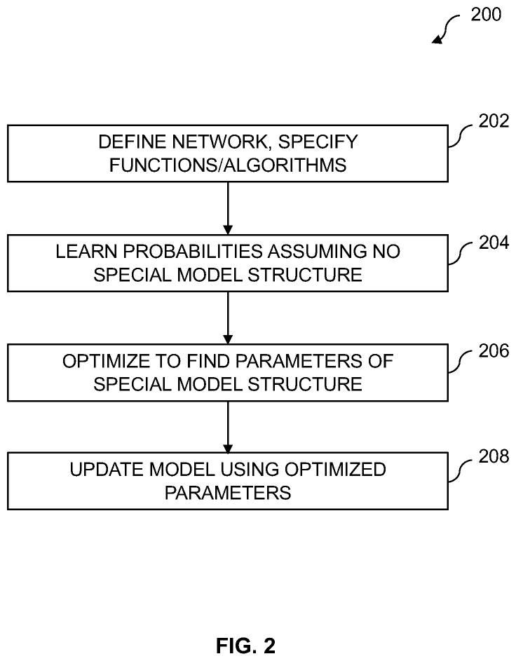

An exemplary process 200, according to embodiments of the present invention, is shown in FIG. 2. Process 200 begins with step 202, in which a Bayesian network including a special model structure is defined and two functions or algorithms are specified—a general function or algorithm by which probabilities is learned and an objective function or algorithm is used for optimization. For example, for probability learning, any general function or algorithm may be used—this may be evaluated using data that may utilize all examples including missing data. For optimization, any objective function or algorithm may be used. An example of a suitable function or algorithm may be a distance measure between the probabilities derived from the parameters of the specialized model structure and the learned probabilities determined by the general function or algorithm. In addition, embodiments may weight this distance by the number of examples present for each case.

At step 204, the probabilities between each node and its parent node in the Bayesian network including a special model structure are learned using the specified general function or algorithm. During this learning process, the function or algorithm used may be evaluated on the assumption that the Bayesian network includes no special model structure. Such algorithms may include maximum likelihood estimation, Bayesian Learning and Expectation Maximization.

At step 206, an optimization function or algorithm may be used to find the best parameters of the special model structure that describe the learned probabilities. For an optimization algorithm, again any optimization may be used—starting from formal optimization algorithm to heuristic ones. For example, for the noisy-or model, a linear programming model may be specified as detailed below. For example, other types of structures of algorithms may include convex optimization algorithms, gradient free optimization algorithms, and heuristic optimization algorithms such as Tabu Search and genetic algorithms.

Formally, this may be defined as follows for the noisy-or model. Each probability is either of the form

$$( 1 - {λ}_{i}^{0} ) {\prod }_{l = 1}^{m} ( 1 - {λ}_{i , l}^{{p}_{jl}} )$$

or of the form

$$1 - ( 1 - {λ}_{i}^{0} ) {\prod }_{l = 1}^{m} ( 1 - {λ}_{i , l}^{{p}_{jl}} ) .$$

Assume that each probability is of the first form and that the value is p. If the value were exact, and if the noisy-or model is able to capture this probability, then

$$( 1 - {λ}_{i}^{0} ) {\prod }_{1 = 1}^{m} ( 1 - {λ}_{i , l}^{{p}_{jl}} ) = p$$

$$or$$

$$log ( 1 - {λ}_{i}^{0} ) + {\sum }_{l = 1}^{m} log ( 1 - {λ}_{i , l}^{{p}_{jl}} ) = log p .$$

Denote by Zᵢ⁰ [symbol] log(1−λᵢ⁰) or by Z_{i,l}^{p}^{ⱼₗ} [symbol] log(1−λ_{i,l}^{p}^{ⱼₗ}). Then

$${Z}_{i}^{0} + {\sum }_{l = 1}^{m} {Z}_{i , l}^{{p}_{jl}} = log p .$$

However, as the estimate is not exact, a deviation with a weight may be added, and then

$${Z}_{i}^{0} + {\sum }_{l = 1}^{m} {Z}_{i , l}^{{p}_{jl}} = log p + w \cdot d ,$$

where the weight is proportional to the number of examples that helped determine p. The goal of this weight is to capture two types of deviation: (1) Deviation due to the fact that p was estimated based on a finite sample. (2) Deviation due to the fact that there may be a bias between the noisy-or and the actual model.

Note that if each probability is of the second form, then

$$( 1 - {λ}_{i}^{0} ) {\prod }_{l = 1}^{m} ( 1 - {λ}_{i , l}^{{p}_{jl}} ) = 1 - p$$

and a linear equality may similarly be derived.

At step 208, the model is updated, using the optimized parameters.

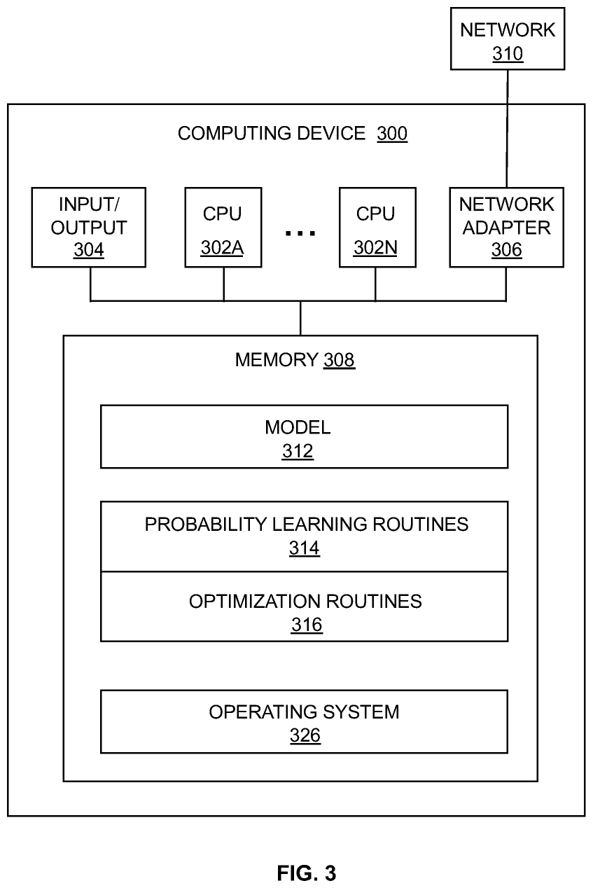

An exemplary block diagram of a computer system 300, in which processes involved in the embodiments described herein are implemented, is shown in FIG. 3. Computer system 300 may be implemented using one or more programmed general-purpose computer systems, such as embedded processors, systems on a chip, personal computers, workstations, server systems, and minicomputers or mainframe computers, or in distributed, networked computing environments. Computer system 300 may include one or more processors (CPUs) 302A-302N, input/output circuitry 304, network adapter 306, and memory 308. CPUs 302A-302N execute program instructions in order to carry out the functions of the present communications systems and methods. Typically, CPUs 302A-302N are one or more microprocessors, such as an INTEL CORE® processor. FIG. 3 illustrates an embodiment in which computer system 300 is implemented as a single multi-processor computer system, in which multiple processors 302A-302N share system resources, such as memory 308, input/output circuitry 304, and network adapter 306. However, the present communications systems and methods also include embodiments in which computer system 300 is implemented as a plurality of networked computer systems, which may be single-processor computer systems, multi-processor computer systems, or a mix thereof.

Input/output circuitry 304 provides the capability to input data to, or output data from, computer system 300. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 306 interfaces device 300 with a network 310. Network 310 may be any public or proprietary LAN or WAN, including, but not limited to the Internet.

Memory 308 stores program instructions that are executed by, and data that are used and processed by, CPU 302 to perform the functions of computer system 300. Memory 308 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 308 may vary depending upon the function that computer system 300 is programmed to perform. In the example shown in FIG. 3, exemplary memory contents are shown representing routines and data for embodiments of the processes described above. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 3, memory 308 may include model 312, probability learning routines 314, optimization routines 316, and operating system 326. Model 312 may include data and software routines to implement a Bayesian network model, including special model structures, as described above. Probability learning routines 314 may include software routines to implement a general function or algorithm by which probabilities may be learned, as described above. Data curation routines 316 may include software routines to implement an optimization function or algorithm may be used to find the best parameters of the special model structure that describe the learned probabilities, as described above. Operating system 326 may provide overall system functionality.

As shown in FIG. 3, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux®, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method for data processing, the method comprising:
providing a Bayesian network model including a special model structure;
learning probabilities between at least one node of the Bayesian network model and a parent node of the Bayesian network model, wherein learning the probabilities is performed by assuming no special model structure is included in the Bayesian network model;
optimizing parameters that describe learned probabilities of the Bayesian network model including the special model structure; and
updating the Bayesian network model including the special model structure using optimized parameters.

2. The computer-implemented method of claim 1, wherein learning the probabilities comprises evaluating the Bayesian network model without the special model structure using data.

3. The computer-implemented method of claim 2, wherein learning the probabilities further comprises generating a weight using a function for each set of values.

4. The computer-implemented method of claim 1, wherein optimizing the parameters comprises determining a set of parameters that minimizes a distance function between probabilities derived from determined parameters of the special model structure and the learned probabilities.

5. The computer-implemented method of claim 4, wherein optimizing the parameters further comprises generating a weight of the distance function by a number of values present for each case.

6. The computer-implemented method of claim 1, wherein the special model structure is a non-generic Conditional Probability Distribution (CPD), including one of a noisy-or probability model structure, a generalized linear model, a deterministic conditional probability distribution, and a context specific conditional probability distribution.

7. A computer system for data processing, the computer system comprising a processor, memory accessible by the processor, and computer program instructions stored in the memory and executable by the processor to perform:
providing a Bayesian network model including a special model structure;
learning probabilities between at least one node of the Bayesian network model and a parent node of the Bayesian network model, wherein learning the probabilities is performed by assuming no special model structure is included in the Bayesian network model;
optimizing parameters that describe learned probabilities of the Bayesian network model including the special model structure; and
updating the Bayesian network model including the special model structure using optimized parameters.

8. The computer system of claim 7, wherein learning the probabilities comprises evaluating the Bayesian network model without the special model structure using data.

9. The computer system of claim 8, wherein learning the probabilities further comprises generating a weight using a function for each set of values.

10. The computer system of claim 7, wherein optimizing the parameters comprises determining a set of parameters that minimizes a distance function between probabilities derived from determined parameters of the special model structure and the learned probabilities.

11. The computer system of claim 10, wherein optimizing the parameters further comprises generating a weight of the distance function by a number of values present for each case.

12. The computer system of claim 7, wherein the special model structure is a non-generic Conditional Probability Distribution (CPD), including one of a noisy-or probability model structure, a generalized linear model, a deterministic conditional probability distribution, and a context specific conditional probability distribution.

13. A computer program product for data processing, the computer program product comprising a computer readable storage medium having program instructions embodied therewith, the program instructions executable by one or more processors to perform:
providing a Bayesian network model including a special model structure;
learning probabilities between at least one node of the Bayesian network model and a parent node of the Bayesian network model, wherein learning the probabilities is performed by assuming no special model structure is included in the Bayesian network model;
optimizing parameters that describe learned probabilities of the Bayesian network model including the special model structure; and
updating the Bayesian network model including the special model structure using optimized parameters.

14. The computer program product of claim 13, wherein learning the probabilities comprises evaluating the Bayesian network model without the special model structure using data.

15. The computer program product of claim 14, wherein learning the probabilities further comprises generating a weight using a function for each set of values.

16. The computer program product of claim 13, wherein optimizing the parameters comprises determining a set of parameters that minimizes a distance function between probabilities derived from determined parameters of the special model structure and the learned probabilities.

17. The computer program product of claim 16, wherein optimizing the parameters further comprises generating a weight of the distance function by a number of values present for each case.

18. The computer program product of claim 13, wherein the special model structure is a non-generic Conditional Probability Distribution (CPD), including one of a noisy-or probability model structure, a generalized linear model, a deterministic conditional probability distribution, and a context specific conditional probability distribution.
